(19) United States
(12) Patent Application Publication
(10) Pub. No.: US 2009/0172373 A1
(43) Pub. Date: Jul. 2, 2009

(54) Ethernet based Automotive Infotainment Power Controller

(76) Inventors: Antonio Sousa Lopes, Mineola, NY (US); Sharif M. Ibrahim, Smithtown, NY (US); Mark F. Bonfiglio, Ronkonkoma, NY (US); Daniel Thomas Thornton, Bellport, NY (US)

Correspondence Address: Sharif Ibrahim, 235 Peconic Street, Ronkonkoma, NY, 11779, US

(21) Appl. No.: 11/968,598

(22) Filed: Jan. 2, 2008

(51) Int. Cl. G06F 9/24

(52) U.S. Cl. 713/1

(57) ABSTRACT

An Automotive Infotainment Power Controller. It utilizes a PIC Micro-Controller, TCP/IP Stack, and a 10 Mbit Ethernet connection as an industry-standard interface by which the Automotive Infotainment Power Controller is connected to any number of Personal Computers. This infrastructure allows custom FW to be developed for the Power Controller that can interact with PC drivers. It also opens the door for bi-directional communication between multiple Personal Computers and the Power Controller. Any number of protocols can be chosen or developed to facilitate this communication over standard Ethernet TCP/IP packets. Having this Ethernet-based communication pipeline between the Power Controller and PCs allows the system to be configured, provide diagnostic/status information, communicate with, and individually Start-Up/Shut-Down PCs connected to the system.

### FIELD OF THE INVENTION

The present invention relates to automotive power controllers and, more particularly, to a controller used to power components of an automotive infotainment system such as a personal computer and associated peripherals.

### BACKGROUND OF THE INVENTION

After-market Automotive Infotainment systems are often based around personal computers in the form of a notebook or desktop. It is extremely desirable if these machines (along with a variety of associated peripherals such as touch screens, mp3 players, etc . . . ) can be connected to the car's electrical power system and turned on or off remotely.

Automotive Infotainment Power Controllers attempt to address a multitude of challenges associated with this task such as:
Filtering noisy Automotive Power Supplies and converting them to 3.3 volts for on-board digital electronics.
Monitoring Battery current to determine if a low-battery situation exists or if the infotainment system is hung and not able to power down.
The PC and associated peripherals need to be powered up and down in a specific sequence to guarantee proper functionality and eliminate the potential for data corruption or hardware failure.
A mechanism to wake or sleep the PC via external devices whether they are connected peripherals or status signals from the automobile (car alarms, ignition/accessory, etc . . . ).
The temperature of the environment needs to be closely monitored to avoid powering up the system when it is too cold or hot for safe operation.

User programmability of the aforementioned functions is critical in configuring the Power Controller for optimal functionality. It is also very useful to communicate with the Power Controller to extract information about environmental temperature, wake-up sources, etc . . . .

A unique issue that has not been addressed is how to offer a common industry standard interface for configuration, diagnostics, communication, and PC Start-Up/Shut-Down for Desktops and Notebooks in an Automotive Infotainment system. An interface that yields the following advantages would be optimal:

1) Allows any over-the-counter home computer to be used as the keystone of the Infotainment system without custom modification.

2) Eases installation of the system by reducing the number of required connections between the PC and Power Controller. It should also be capable of having these devices located a reasonable distance apart.

3) Allow the Power Controller to be completely configurable and constantly monitored from a Software Application running on the Personal Computer.

4) Offer integrators the ability to have “canned” solutions in PC configuration files which can be downloaded to the Controller. This would provide a quick and easy method to set up the system.

5) Allow users to create custom API's that can communicate with the PC Controller for a variety of unique applications.

6) Allows multiple PCs to be connected to a single Power Controller. The Power Controller would be able to communicate with all the PCs and Start-Up/Shut-Down each individually. The PC should also be able to Shut-Down the Infotainment System and place the Power Controller into a low-power state.

7) Provide the ability to perform Firmware upgrades to the Power Controller.

Several companies have marketed products that address powering automotive infotainment systems. Naturally, all devices provide the basic required functionality. Some have more user convenience features or flexible configuration capabilities than others.

A basic overview of how each product can be configured, how it starts-up/shuts-down the PC, and the implemented interfaces is provided below:

Dashwerks DSSC:
Device Configuration: This device is limited to 5 user adjustable timing controls. The method of adjustment is manually via dials on the Power Controller Board.
5 Indicator LEDs: These are used for diagnostics and tuning.
An ACPI switch header: This is a 2 pin connector that is designed to connect to the power connector on a computer motherboard. This header can be connected to other motherboard connectors—such as Wake-On-Lan (WOL) and Ring Indicator (RI). Direct access to the motherboard of an ACPI complaint computer is required.
Serial port connector: This connector provides an alternate method of shutting down a PC. By connecting this port to an industry standard computer serial port your computer can be halted (driver software may be required).

MPEGBOX uSDC20D:
Option Jumpers: Used to select pre-determined Controller Configurations.
Potentiometer Probe Points: A voltmeter is needed to measure the voltage at these points. This value is used to manually calculate timing delays. Adjustment of timing delays must be done by physically changing on-board potentiometers.
Indicator LED: Single LED with different Blink Rates to communicate Status.
Power switch header: This is a 2 pin connector that is designed to connect to the power connector on a computer motherboard.
Computer Power Sense Pin: A signal diode needs to be connected from the 4-port Molex of a Computer Hard Drive or CD-ROM Power Connector. This is how the uSDC20D detects if the Computer is On.

CarPC Platinum:
Configuration Mode Button: A button on the Power Controller must be pressed to enter “Configuration Mode”, scroll through available settings, and change settings.
Setting LEDs: A row of LED's is used to indicate to the user which setting is selected when in “Configuration Mode”. Also used to indicate Status when in normal functional mode.
Jumpers: Are used to select a value for each of the available configuration settings. Once the Configuration Mode Button is pressed the value is saved in memory and the jumper can be removed.
Power switch header: This is a 2 pin connector that is designed to connect to the power connector on a computer motherboard. The Power Controller must be mounted inside or very close to an ACPI compliant PC.
Serial port connector: By connecting this port to an industry standard computer and installing custom Software the PC can be shut down by the Controller. User configuration of the Shut-Down process is also available via Software.
PC Watchdog Header: 2-pin connecter on Power Controller that must be wired to the PC Serial Port to monitor PC activity.

From the summaries above it is clear that no existing device even attempts to solve the entire problem set that was defined. The following are shortcomings of the existing devices:

1) No device possesses a single interface for configuration, diagnostics, communication, and PC Start-Up/Shut-Down. They employ 2-Pin Power/ACPI headers, Serial Port connections, and Status signals from the PC to function as advertised.

2) The ability to connect the Power Controller to a PC (whether Desktop or Notebook) without direct access to the motherboard does not exist. 2-pin headers need to be connected to the motherboard's power button connection or ACPI WOL connections. This means physical de-assembly and/or wire routing to PC internals is required.

3) Another limitation of using 2-pin power headers is that the Power Controller must be placed close to the PC. These connections are not capable of driving wires over long distances. This physical layout restriction can be inconvenient to some users.

4) The Serial Port Connection is only capable of Shutting-Down a Notebook PC. It can not be used as a Start-Up interface. Many modern computers don't even have Serial Port connections anymore, so seamless integration of even this limited feature may not be possible.

5) Multiple PCs can not be connected to a single Power Controller and be individually Started-Up/Shut-Down. The Power Control Header, even if connected to multiple computers, can't distinguish between one and the other. For Notebook PCs the Serial Port is a point-to-point interface so there can only be 1 device connected to it.

6) Configuration of all the aforementioned Power Controllers must be done manually by pressing buttons, observing LED states, and applying jumpers. Complete configuration via Software (step-by-step or via complete configuration files) on the PC does not exist.

7) None of these products offer a way for the PC to communicate with the Power Controller. There is no mechanism to transfer diagnostic information or device status back to a Software Application running on the PC. This means that users can not create custom APIs for unique applications utilizing information that the Power Controller may possess.

8) Of the devices that are capable of performing Firmware upgrades a Serial Port connection is required to the PC. Some Notebooks no longer offer this interface. In this case a Serial Port to USB connector would be required to perform the Firmware upgrade.

It is therefore an object of the invention to connect a personal computer and associated peripherals to an automobile's power supply.

It is another object of the invention to Start-Up or Shut-Down personal computers in an automotive infotainment system remotely.

It is another object of the invention to allow any over-the-counter home computer (desktop or notebook) to be used as the keystone of the Infotainment system without custom modification.

It is another object of the invention to ease installation of the system by reducing the number of required connections between the PC and Power Controller. It should also be capable of having these devices located a reasonable distance apart.

It is another object of the invention to allow the Power Controller to be completely configurable and constantly monitored from a Software Application running on the Personal Computer.

It is another object of the invention to offer integrators the ability to have “canned” solutions in PC configuration files which can be downloaded to the Controller. This would provide a quick and easy method to set up the system.

It is another object of the invention to allow users to create custom API's that can communicate with the PC Controller for a variety of unique applications.

It is another object of the invention to allow multiple PCs to be connected to a single Power Controller. The Power Controller would be able to communicate with all the PCs and Start-Up/Shut-Down each individually. The PC should also be able to Shut-Down the Infotainment System and place the Power Controller into a low-power state.

It is another object of the invention to provide the ability to perform FW upgrades to the Power Controller.

### SUMMARY OF THE INVENTION

In accordance with the present invention, there is provided an Automotive Infotainment Power Controller. It utilizes a PIC Micro-Controller, TCP/IP Stack, and a 10 Mbit Ethernet connection as an industry-standard interface by which the Automotive Infotainment Power Controller is connected to any number of Personal Computers. This infrastructure allows custom Firmware to be developed for the Automotive Infotainment Power Controller that can interact with PC device drivers. It also opens the door for bi-directional communication between multiple Personal Computers and the Automotive Infotainment Power Controller. Any number of protocols can be chosen or developed to facilitate this communication over standard Ethernet TCP/IP packets. Having this Ethernet-based communication pipeline between the Automotive Infotainment Power Controller and PCs allows the system to be configured, provide diagnostic/status information, communicate with, and individually Start-Up/Shut-Down PCs connected to the system.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an automotive infotainment power controller pc interface; and

FIG. 2 is an example of a host & target device protocol stacks view.

For purposes of clarity and brevity, like elements and components will bear the same designations and numbering throughout the Figures.

### DESCRIPTION OF THE PREFERRED EMBODIMENT

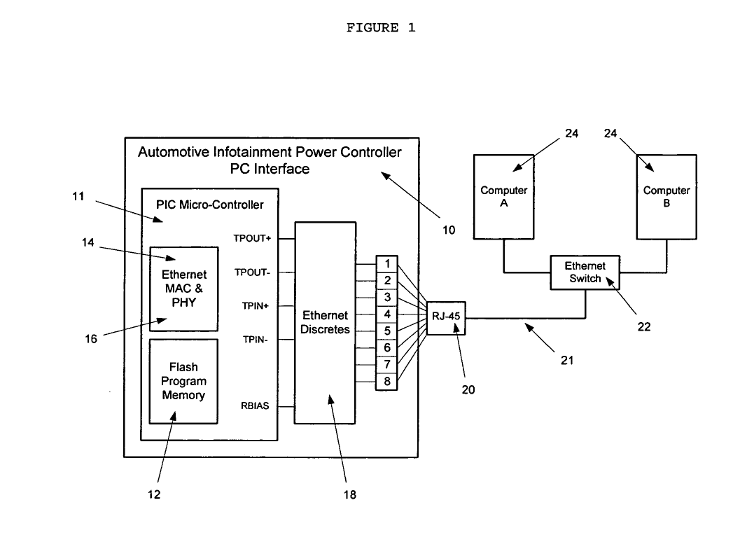

FIG. 1 is a perspective view of an automotive infotainment power controller 10 pc interface. The centerpiece is a PIC Micro-Controller 11, such as the PIC18F97J60 manufactured by Microchip Technology Inc. Custom Firmware which manages the full functionality of the power Controller will be loaded into the embedded flash program memory 12. The PIC Micro-Controller 11 also provides an integrated IEE802.3 compliant Ethernet MAC 14, 10BaseT PHY transceiver module 16, and a native TCP/IP Stack. The Ethernet cable connecter is a standard RJ-45 connector 20 with the required pulse transformers, chokes, and resistors included on the board (Ethernet discretes module 18). The structure of the analog components within the Ethernet discretes module 18 is customized to meet the requirements of the various PIC Micro-controllers that may be used for this implementation.

The overall Hardware system may optionally include an Ethernet switch 22 that connects multiple personal computers 24 (whether it be a desktop or notebook) to the network using an industry standard CAT5 cable 21.

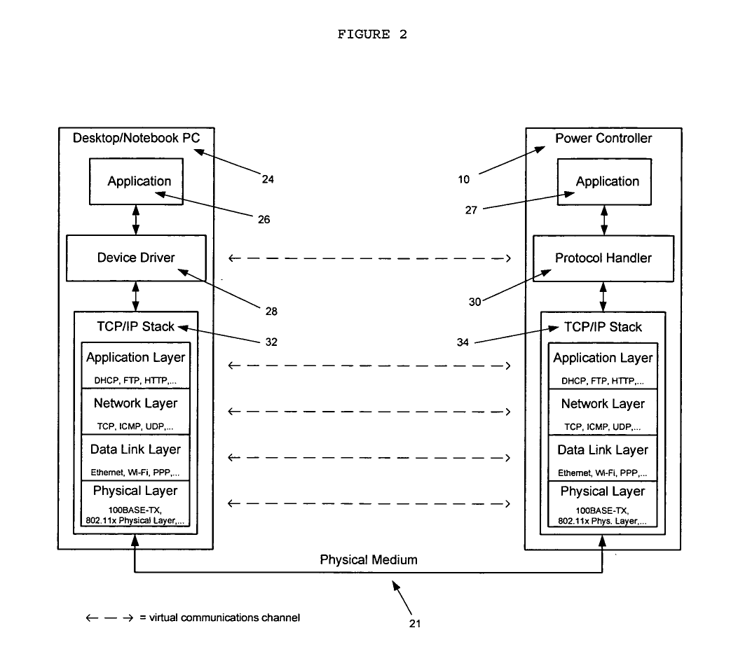

FIG. 2 is an example of a Host & Target device protocol stacks view. Along with a TCP/IP Stack on the PC 32 and a TCP/IP Stack on the Power Controller 34 the Software system utilizes a device driver 28 on the PC and a protocol handler 30 on the automotive infotainment power controller 10. Communication with the Hardware will be done via this dedicated channel that talks to the hardware “natively”. The drivers will then talk to plug-ins, which will in turn talk to the PC application software 26 and Power Controller application software 27.

The usage model for this Software System has the following features. It enforces a command/response type of protocol. It provides a uniform data, command, and status transport mechanism customized to the needs of the network. It also allows for a level of abstraction that permits application software to be network-agnostic. Application-layer software will initiate traffic (commands/status queries/data transfers) via the device drivers.

In operation, the setup and functional features of the combined Hardware/Software system pictured in FIGS. 1 and 2 are as follows:

1) Attaching a CAT5 cable 21 between the RJ-45 connector 20 on the automotive infotainment power controller 10 and any Desktop or Notebook PC is all the system requires. If multiple personal computers 24 are to be used a standard Ethernet switch 22 can be added. The automotive infotainment power controller 10 is connected to the Ethernet switch 22 which is then connected to every PC in the system. There is no restriction on where to locate of any of these components other than the length of the available CAT5 cable 21.

2) PC application software 26 is configured to seek out the automotive infotainment power controller 10 as the DHCP Controller. The automotive infotainment power controller 10 can then create an ARP table which will contain each PC's MAC Address. The DHCP Master function will then set up an IP Address for each PC connected to the network. With this configuration point-to-point bi-directional communication between a specific PC on the network and the automotive infotainment power controller 10 is possible.

3) Any number of protocols, which embed data within TCP/IP packets, can be chosen or developed to facilitate communication between the automotive infotainment power controller 10 and PC device driver 28. This allows the use of PC application software 26 to modify Configuration Registers within the automotive infotainment power controller 10 to adjust functionality. Status Registers can also be read to retrieve any information the automotive infotainment power controller 10 may possess.

4) PC application software 26 can also easily be developed that allows “canned” solutions in PC configuration files to be downloaded to the automotive infotainment power controller 10 and configure it quickly and easily. This would look like raw data being blasted from the PC to the automotive infotainment power controller 10 across the Ethernet channel. The target of this data would be the configuration register space within the PIC Micro-Controller 11.

5) A Firmware Upgrade Application can also be developed to re-program the PIC Micro-Controller 11 embedded flash program memory 12. First a new Firmware image is downloaded by the PC application software 26. It would then send a unique command that puts the automotive infotainment power controller 10 into “Program” mode. The PC application software 26 can then blast raw data containing the Firmware image to the automotive infotainment power controller 10 which will save it in the PIC Micro-Controller 11 Non-volatile embedded flash program memory 12. Once this is complete the PC application software 26 sends another unique command to put the automotive infotainment power controller 10 back into “Normal Operational” mode.

6) The TCP/IP ARP Table that was created during System Setup gives the automotive infotainment power controller 10 a list of every PC's MAC Address. This allows it to create Magic Packets (an IP packet with 16 copies of the MAC Address in the Data Payload) which can be sent to any PC connected to the network. Any PC can be configured through its BIOS to accept a Magic Packet which will be interpreted as a Wake-On-LAN message. When this packet is received the PC will automatically resume from a Standby (S3), Hibernate (S4), or Soft-Off (S5) sate.

7) The automotive infotainment power controller 10 can Shut-Down any PC by responding to a specific Status Poll. The PC device driver 28 can interpret this response as a Shut-Down command. A user application will then choose to completely Shut-Down, transition to Hibernate, or enter the Soft-Off state depending on a user configuration.

8) Any PC has the ability to Shut-Down the Infotainment system by sending a Sleep Command to the automotive infotainment power controller 10. This will instruct the automotive infotainment power controller 10 to Power Down the entire system and transition into a low power mode to conserve the car battery.

9) The Status of the PC can be easily determined by monitoring its Polling Frequency. If the PC is hung it will not be able to regularly communicate with the automotive infotainment power controller 10. A simple Watch-Dog Timer can be used to reset the PC if it doesn't communicate with the automotive infotainment power controller 10 within a designated time frame.

Some of the major differences and respective advantages between existing devices and the combined Hardware/Software system pictured in FIGS. 1 and 2 are as follows:

1) The only connection required between any personal computer and the proposed Ethernet based automotive infotainment power controller 10 is an Ethernet CAT5 cable 21. This is not the case with any of the existing devices which utilize 2-pin Power Connector/WOL headers for some applications and Serial Ports for others. Connection of the 2-pin header requires direct access to the PC motherboard and physical de-assembly/manual wiring. It is much more convenient to simply connect a CAT5 cable 21 to standard connectors on the automotive infotainment power controller 10 and any commercially available PC.

2) Another benefit of using Ethernet is that the PC and automotive infotainment power controller 10 need not be placed in close proximity. This is not the case when using the 2-pin headers. Ethernet CAT5 cable 21 connections are designed for handling significant distances between devices. This offers another competitive advantage in allowing users greater flexibility on where to install required components.

3) The use of a Serial Port connector between the automotive infotainment power controller 10 and a Notebook PC has several limitations. First, it is only capable of Shutting-Down a PC by sending a command to it. There is no provision on standard PCs to be woken up via Serial Port communication. Secondly, many PCs no longer offer Serial Port connections. Ethernet, on the other hand, is capable of Starting-Up (via WOL Packets) and Shutting Down (via Status Transfer) both Desktop and Notebook PCs. It is a standard interface available on all PCs or easily added by installation of a NIC card. This allows the proposed automotive infotainment power controller 10 to be connected to any commercial PC without complication.

4) Existing devices were designed to handle a single PC in the Infotainment system. By basing the automotive infotainment power controller 10 around an Ethernet Interface, multiple computers can be connected to a single automotive infotainment power controller 10. Since Ethernet based network allows each device to have a unique IP address, communication between individual devices is possible. This allows our proposed system to individually Start-Up/Shut-Down any connected PC.

5) Configuration of the is achieved via the PC application software 26. It can be done by changing settings individually or “canned” complete configuration files that can be transferred to the automotive infotainment power controller 10. All existing devices require manual button pushes, observing LED status, and adding/removing jumpers. The proposed solution is much more user-friendly and flexible.

6) Another difference between the proposed solution and the prior art is offering a fully capable communication interface between the PC and automotive infotainment power controller 10. No other device offers this capability. The benefits of such an interface are that it offers a mechanism to transfer diagnostic information or device status back to a PC software application. This allows users to create custom APIs for unique applications utilizing information that the automotive infotainment power controller 10 may possess.

7) Automotive infotainment power controller 10 Firmware Upgrades can be accomplished using the same Ethernet Interface that all other functions employ. This means that the required connection already exists and is in place. All other Prior Art requires a Serial Port connection to perform a Firmware Upgrade. This would have to be connected manually for the sole purpose of doing the upgrade. On Notebook PCs which don't have Serial Ports a converter to an interface such as USB would be required to accomplish this task.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An ethernet based automotive infotainment power controller for connecting a personal computer and associated peripherals to the car's electrical power system, comprising: means for connecting personal computers and associated peripherals to a car's power supply while supplying a mechanism to remotely start and shut them down;
means for execution of internal firmware that manages operation of the entire power controller. it also provides an ethernet mac, 10baset phy, and tcp/ip stack. these are all required components for implementing an industry standard ethernet interface, internally mounted to said means for connecting personal computers and associated peripherals to a car's power supply while supplying a mechanism to remotely start and shut them down;
means for providing non-volatile storage of firmware which is executed by the micro-controller to manage all power control functions, internally embedded to said means for execution of internal firmware that manages operation of the entire power controller. it also provides an ethernet mac, 10baset phy, and tcp/ip stack. these are all required components for implementing an industry standard ethernet interface;
means for providing iee802.3 compliant media access control and an interface to control the phy, internally embedded to said means for execution of internal firmware that manages operation of the entire power controller. it also provides an ethernet mac, 10baset phy, and tcp/ip stack. these are all required components for implementing an industry standard ethernet interface;
means for encoding and decoding the analog data on the twisted pair interface and sending or receiving it over the network, electrically connected to said means for providing iee802.3 compliant media access control and an interface to control the phy, and internally embedded to said means for execution of internal firmware that manages operation of the entire power controller. it also provides an ethernet mac, 10baset phy, and tcp/ip stack. these are all required components for implementing an industry standard ethernet interface;
means for providing the pulse transformers, resistors, and chokes required to connect the phy interface to the rj45 connector, electrically connected to said means for encoding and decoding the analog data on the twisted pair interface and sending or receiving it over the network, and internally mounted to said means for connecting personal computers and associated peripherals to a car's power supply while supplying a mechanism to remotely start and shut them down;
means for providing the industry-standard ethernet cat5 cable connection to the power controller, electrically connected to said means for providing the pulse transformers, resistors, and chokes required to connect the phy interface to the rj45 connector, and internally mounted to said means for connecting personal computers and associated peripherals to a car's power supply while supplying a mechanism to remotely start and shut them down;
means for connecting the power controller to an ethernet switch or to a personal computer, electrically connected to said means for providing the industry-standard ethernet cat5 cable connection to the power controller;
means for initiating traffic with a level of abstraction that allows for network-agnostic coding;
means for providing responses with a level of abstraction that allows for network-agnostic coding, internally embedded to said means for providing non-volatile storage of firmware which is executed by the micro-controller to manage all power control functions;
means for initiating traffic to the protocol handler via a dedicated channel that talks to the hardware “natively”. will also talk to plug-ins which then talk to software applications, bi-directionally communicating to said means for initiating traffic with a level of abstraction that allows for network-agnostic coding;
means for providing “native” responses to the device driver over the dedicated channel. will also talk to plug-ins which will talk to software applications, virtually communicating to said means for initiating traffic to the protocol handler via a dedicated channel that talks to the hardware “natively”. will also talk to plug-ins which then talk to software applications, bi-directionally communicating to said means for providing responses with a level of abstraction that allows for network-agnostic coding, and internally embedded to said means for providing non-volatile storage of firmware which is executed by the micro-controller to manage all power control functions;
means for providing a suite of programs that service standard tcp/ip applications, bi-directionally communicating to said means for initiating traffic to the protocol handler via a dedicated channel that talks to the hardware “natively”. will also talk to plug-ins which then talk to software applications; and
means for providing a suite of programs that service standard tcp/ip applications, virtually communicating to said means for providing a suite of programs that service standard tcp/ip applications, bi-directionally communicating to said means for providing “native” responses to the device driver over the dedicated channel. will also talk to plug-ins which will talk to software applications, and internally embedded to said means for providing non-volatile storage of firmware which is executed by the micro-controller to manage all power control functions.

2. The ethernet based automotive infotainment power controller in accordance with claim 1, wherein said means for connecting personal computers and associated peripherals to a car's power supply while supplying a mechanism to remotely start and shut them down comprises a pic micro-controller, ethernet mac and 10baset phy, industry-standard rj-45 connector automotive infotainment power controller.

3. The ethernet based automotive infotainment power controller in accordance with claim 1, wherein said means for execution of internal firmware that manages operation of the entire power controller. it also provides an ethernet mac, 10baset phy, and tcp/ip stack. these are all required components for implementing an industry standard ethernet interface comprises an ethernet mac, 10baset phy, tcp/ip stack, flash program memory to store firmware pic micro-controller.

4. The ethernet based automotive infotainment power controller in accordance with claim 1, wherein said means for providing non-volatile storage of firmware which is executed by the micro-controller to manage all power control functions comprises a flash program memory.

5. The ethernet based automotive infotainment power controller in accordance with claim 1, wherein said means for providing iee802.3 compliant media access control and an interface to control the phy comprises an ieee802.3 compliant mac logic, interface to control the phy ethernet mac.

6. The ethernet based automotive infotainment power controller in accordance with claim 1, wherein said means for encoding and decoding the analog data on the twisted pair interface and sending or receiving it over the network comprises a 10baset compliant phy transceiver module.

7. The ethernet based automotive infotainment power controller in accordance with claim 1, wherein said means for providing the pulse transformers, resistors, and chokes required to connect the phy interface to the rj45 connector comprises an ethernet discretes module.

8. The ethernet based automotive infotainment power controller in accordance with claim 1, wherein said means for providing the industry-standard ethernet cat5 cable connection to the power controller comprises an industry-standard rj-45 connector.

9. The ethernet based automotive infotainment power controller in accordance with claim 1, wherein said means for connecting the power controller to an ethernet switch or to a personal computer comprises an industry-standard cat5 cable.

10. The ethernet based automotive infotainment power controller in accordance with claim 1, wherein said means for initiating traffic with a level of abstraction that allows for network-agnostic coding comprises a pc application software.

11. The ethernet based automotive infotainment power controller in accordance with claim 1, wherein said means for providing responses with a level of abstraction that allows for network-agnostic coding comprises a power controller application software.

12. The ethernet based automotive infotainment power controller in accordance with claim 1, wherein said means for initiating traffic to the protocol handler via a dedicated channel that talks to the hardware “natively”. will also talk to plug-ins which then talk to software applications comprises a device driver.

13. The ethernet based automotive infotainment power controller in accordance with claim 1, wherein said means for providing “native” responses to the device driver over the dedicated channel. will also talk to plug-ins which will talk to software applications comprises a protocol handler.

14. The ethernet based automotive infotainment power controller in accordance with claim 1, wherein said means for providing a suite of programs that service standard tcp/ip applications comprises a native tcp/ip stack on the pc.

15. The ethernet based automotive infotainment power controller in accordance with claim 1, wherein said means for providing a suite of programs that service standard tcp/ip applications comprises a native tcp/ip stack on the power controller.

16. An ethernet based automotive infotainment power controller for connecting a personal computer and associated peripherals to the car's electrical power system, comprising: a pic micro-controller, ethernet mac and 10baset phy, industry-standard rj-45 connector automotive infotainment power controller, for connecting personal computers and associated peripherals to a car's power supply while supplying a mechanism to remotely start and shut them down;
an ethernet mac, 10baset phy, tcp/ip stack, flash program memory to store firmware pic micro-controller, for execution of internal firmware that manages operation of the entire power controller. it also provides an ethernet mac, 10baset phy, and tcp/ip stack. these are all required components for implementing an industry standard ethernet interface, internally mounted to said automotive infotainment power controller;
a flash program memory, for providing non-volatile storage of firmware which is executed by the micro-controller to manage all power control functions, internally embedded to said PIC Micro-Controller;
an ieee802.3 compliant mac logic, interface to control the phy ethernet mac, for providing iee802.3 compliant media access control and an interface to control the phy, internally embedded to said PIC Micro-Controller;
a 10baset compliant phy transceiver module, for encoding and decoding the analog data on the twisted pair interface and sending or receiving it over the network, electrically connected to said Ethernet MAC, and internally embedded to said PIC Micro-Controller;
an ethernet discretes module, for providing the pulse transformers, resistors, and chokes required to connect the phy interface to the rj45 connector, electrically connected to said PHY transceiver module, and internally mounted to said automotive infotainment power controller;
an industry-standard rj-45 connector, for providing the industry-standard ethernet cat5 cable connection to the power controller, electrically connected to said ethernet discretes module, and internally mounted to said automotive infotainment power controller;
an industry-standard cat5 cable, for connecting the power controller to an ethernet switch or to a personal computer, electrically connected to said RJ-45 connector;
a pc application software, for initiating traffic with a level of abstraction that allows for network-agnostic coding;
a power controller application software, for providing responses with a level of abstraction that allows for network-agnostic coding, internally embedded to said flash program memory;
a device driver, for initiating traffic to the protocol handler via a dedicated channel that talks to the hardware “natively”. will also talk to plug-ins which then talk to software applications, bi-directionally communicating to said PC application software;
a protocol handler, for providing “native” responses to the device driver over the dedicated channel. will also talk to plug-ins which will talk to software applications, virtually communicating to said device driver, bi-directionally communicating to said Power Controller application software, and internally embedded to said flash program memory;
a native tcp/ip stack on the pc, for providing a suite of programs that service standard tcp/ip applications, bi-directionally communicating to said device driver; and
a native tcp/ip stack on the power controller, for providing a suite of programs that service standard tcp/ip applications, virtually communicating to said TCP/IP Stack on the PC, bi-directionally communicating to said protocol handler, and internally embedded to said flash program memory.

17. The ethernet based automotive infotainment power controller as recited in claim 16, further comprising: an ethernet switch, for creating a network which connects multiple personal computers to the power controller, electrically connected to said CAT5 cable.

18. The ethernet based automotive infotainment power controller as recited in claim 16, further comprising: an off the shelf desktop or notebook personal computers, for providing the processing brains of the automotive infotainment system, electrically connected to said Ethernet switch, internally embedded to said PC application software, internally embedded to said device driver, and internally embedded to said TCP/IP Stack on the PC.

19. The ethernet based automotive infotainment power controller as recited in claim 17, further comprising: an off the shelf desktop or notebook personal computers, for providing the processing brains of the automotive infotainment system, electrically connected to said Ethernet switch, internally embedded to said PC application software, internally embedded to said device driver, and internally embedded to said TCP/IP Stack on the PC.

20. An ethernet based automotive infotainment power controller for connecting a personal computer and associated peripherals to the car's electrical power system, comprising: a pic micro-controller, ethernet mac and 10baset phy, industry-standard rj-45 connector automotive infotainment power controller, for connecting personal computers and associated peripherals to a car's power supply while supplying a mechanism to remotely start and shut them down;
an ethernet mac, 10baset phy, tcp/ip stack, flash program memory to store firmware pic micro-controller, for execution of internal firmware that manages operation of the entire power controller. it also provides an ethernet mac, 10baset phy, and tcp/ip stack. these are all required components for implementing an industry standard ethernet interface, internally mounted to said automotive infotainment power controller;
a flash program memory, for providing non-volatile storage of firmware which is executed by the micro-controller to manage all power control functions, internally embedded to said PIC Micro-Controller;
an ieee802.3 compliant mac logic, interface to control the phy ethernet mac, for providing iee802.3 compliant media access control and an interface to control the phy, internally embedded to said PIC Micro-Controller;
a 10baset compliant phy transceiver module, for encoding and decoding the analog data on the twisted pair interface and sending or receiving it over the network, electrically connected to said Ethernet MAC, and internally embedded to said PIC Micro-Controller;
an ethernet discretes module, for providing the pulse transformers, resistors, and chokes required to connect the phy interface to the rj45 connector, electrically connected to said PHY transceiver module, and internally mounted to said automotive infotainment power controller;
an industry-standard rj-45 connector, for providing the industry-standard ethernet cat5 cable connection to the power controller, electrically connected to said ethernet discretes module, and internally mounted to said automotive infotainment power controller;
an ethernet switch, for creating a network which connects multiple personal computers to the power controller;
an industry-standard cat5 cable, for connecting the power controller to an ethernet switch or to a personal computer, electrically connected to said Ethernet switch, and electrically connected to said RJ-45 connector;
an off the shelf desktop or notebook personal computers, for providing the processing brains of the automotive infotainment system, electrically connected to said Ethernet switch;
a pc application software, for initiating traffic with a level of abstraction that allows for network-agnostic coding, internally embedded to said personal computers;
a power controller application software, for providing responses with a level of abstraction that allows for network-agnostic coding, internally embedded to said flash program memory;
a device driver, for initiating traffic to the protocol handler via a dedicated channel that talks to the hardware “natively”. will also talk to plug-ins which then talk to software applications, bi-directionally communicating to said PC application software, and internally embedded to said personal computers;
a protocol handler, for providing “native” responses to the device driver over the dedicated channel. will also talk to plug-ins which will talk to software applications, virtually communicating to said device driver, bi-directionally communicating to said Power Controller application software, and internally embedded to said flash program memory;
a native tcp/ip stack on the pc, for providing a suite of programs that service standard tcp/ip applications, bi-directionally communicating to said device driver, and internally embedded to said personal computers; and
a native tcp/ip stack on the power controller, for providing a suite of programs that service standard tcp/ip applications, virtually communicating to said TCP/IP Stack on the PC, bi-directionally communicating to said protocol handler, and internally embedded to said flash program memory.
